(19) United States
(12) Patent Application Publication
(10) Pub. No.: US 2012/0278904 A1
(43) Pub. Date: Nov. 1, 2012

(54) CONTENT DISTRIBUTION REGULATION BY VIEWING USER

(75) Inventors: Kathryn Stone Perez, Kirkland, WA (US); Alex Aben-Athar Kipman, Redmond, WA (US); Andrew John Fuller, Redmond, WA (US)

(73) Assignee: MICROSOFT CORPORATION, Redmond, WA (US)

(21) Appl. No.: 13/094,444

(22) Filed: Apr. 26, 2011

(51) Int. Cl. G06F 21/24

(52) U.S. Cl. 726/31

(57) ABSTRACT

A content presentation system and method allowing content providers to regulate the presentation of content on a per-user-view basis. Content is distributed an associated license option on the number of individual consumers or viewers allowed to consume the content. Consumers are presented with a content selection and a choice of licenses allowing consumption of the content. The users consuming the content on a display device are monitored so that if the number of user-views licensed is exceeded, remedial action may be taken.

### BACKGROUND

Delivering audiovisual entertainment has progressed from physical media to digital downloads. In delivering such media, content providers often seek compensation based on the number of times content can be presented on a particular system. Audiovisual content, such as a movie, may be presented to a user via streaming to a display device or downloaded to non-volatile storage on a user's display device. The content may then be subject to some restriction, such as a limited number of days within which the content can be played once performance of the content begins. One example is a movie rental, which requires a user to watch the downloaded move within a certain number of days after downloading the movie and initiating a play sequence.

The licensing and display of such content relative a restriction on the number of plays, for example, is generally limited to the content or the device on which it is played.

### SUMMARY

The technology, briefly described, is a content presentation system and method allowing content providers to regulate the presentation of content on a per-user-view basis. Content is distributed to consuming devices, such as televisions, set-top boxes and digital displays, with an associated license option on the number of individual consumers or viewers allowed to consume the content. The limitation may comprise a number of user views, a number of user views over time, a number of simultaneous user views, views tied to user identities, views limited to user age or any variation or combination thereof, all tied to the number of actual content consumers allowed to view the content. Consumers are presented with a content selection and a choice of licenses allowing consumption of the content. In one embodiment, a license manager on the consuming device or on a content providers system manages license usage and content consumption. The users consuming the content on a display device are monitored so that if the number of user-views licensed is exceeded, remedial action may be taken.

In one embodiment, the technology is a method of distributing content to a user. A selection of content is made available to a user. Each item of content has one or more licensing options comprising associating a performance of the content with an individual user's consumption of the content. When the user selects content and a license option, the content is presented to a display device if the license terms are satisfied. This can include a license for a number of user views allowed for the content within a specific time period is equal to or less than the selected license option, or licenses tied to individual user identities. A user view is an individual user consuming the content at a device. The presentation at the device is monitored to determine the number of users consuming the content during the performance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a system for implementing the present technology.

FIG. 2 depicts a general method in accordance with the present technology.

FIG. 3 depicts a method performed on a content display device in accordance with the present technology.

FIG. 4 depicts a method performed on content delivery system in accordance with the present technology.

FIG. 5 depicts an exemplary head mounted display device.

FIG. 6 depicts an exemplary large screen display device.

FIG. 7 depicts an exemplary capture device.

FIG. 8 is a block diagram of an embodiment of a gaming and media system.

FIG. 9 is a block diagram of an embodiment of a mobile device.

FIG. 10 is a block diagram of an embodiment of a computing system environment.

### DETAILED DESCRIPTION

Technology is presented which allows a content provider to present content to consumers at a per-user-view basis. Content is distributed to consuming devices, such as televisions, set-top boxes and digital displays, with an associated limitation on the number of actual consumers or viewers allowed to consume the content. The limitation may comprise a number of views, a number of views over time, a number of simultaneous views, views limited to viewers of a certain age, a free view of a limited portion of the media, or any combination or variation thereof, all tied to the number of actual consumers allowed to view the content. Consumers are presented with a content selection and a choice of licenses allowing consumption of the content. The license regulates consumption of the content by consumer. In one embodiment, a license manager on the consuming device or on a content providers system manages license usage and content consumption.

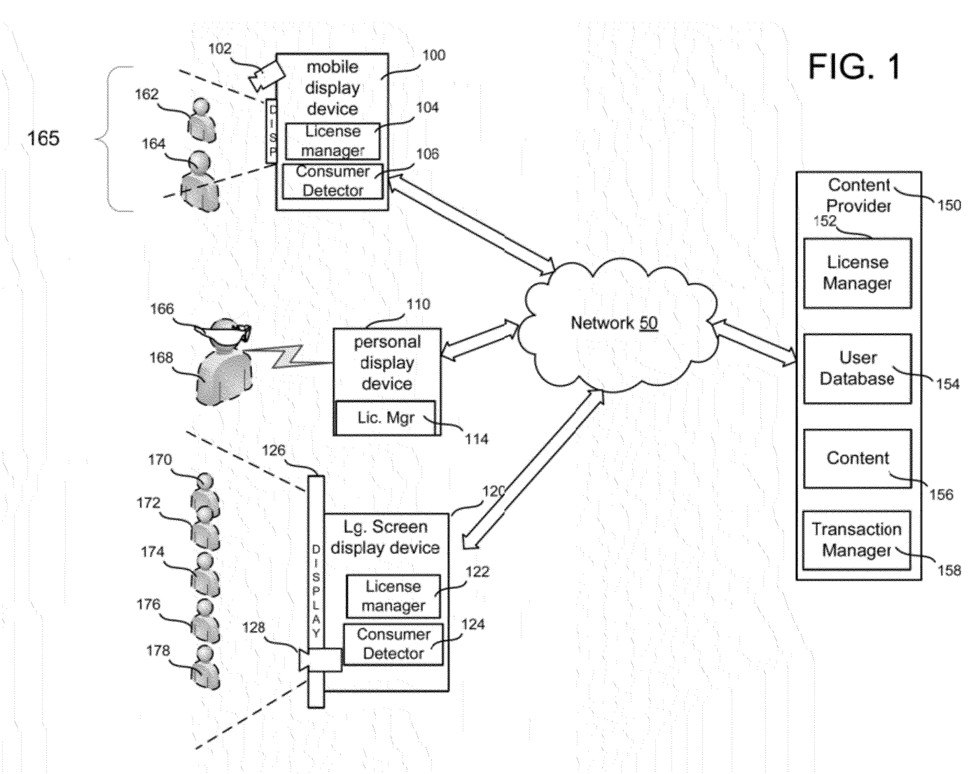

FIG. 1 represents a system in which the present technology may be implemented. In one embodiment a content provider 150 operates one or more processing devices and delivers licensed content 156 to consumers 162-178 who consume the content using a variety of display devices 100, 110, 120. Alternative embodiments and systems may be utilized in accordance with the present technology. While the system in FIG. 1 demonstrates a networked delivery model for the content, the content may be provided on alternative forms of delivery media such as non-volatile memory devices or disks. Further it should be understood that while only one content provider is illustrated in FIG. 1, multiple content providers with the same or different content may be accessible to consumers using display devices.

In one embodiment, content provider 150 includes a license manager 152, a user database 154, a transaction manager 158 and content 156. A transaction manager 158 controls the provision of content listings and consumer transactions with content 156 provided by the content provider 150. Content 156 is provided to the consumer upon selection by the consumer of the content requested and one or more license options to view the content. Content may comprise audio, video, processing device applications, games, or other information which may be displayed on an audio/visual device. Various types of audio/visual devices are discussed herein. When a user selects content for consumption on a device, the transaction manger may control the provision of the content (e.g. by downloading or streaming the content to the display device) as well as any financial transaction required by the content provider as remuneration for providing the content. The user database 154 contains a record of the user information associated with a display device. For example, the user database may contain a user record of the content delivered to the user, the license associated with the content and the user or display device, previous transactions of the user, the user's licenses and license status, and transaction information allowing the user to make additional purchases.

The licenser manager 152 associates licenses with content chosen for distribution to a consumer on one of devices 100, 110, and 120. License manager 152 determines whether performance of the content is consistent with the terms of the license. For example, in accordance with the technology, the license defines one or more of the number of consumers, the number of views per consumer, and/or the time period within which the views per consumer must occur.

One or more display devices 100, 110, 120 may comprise, for example, a mobile device 100 (having a mobile display), a personal or head mounted display device 110, and a large-screen display device 120. Each of the display devices illustrated in FIG. 1 may include hardware and software to implement the functions described herein. In the context of this description, the large-scale display device 120 may be any device suitable for use by more than one or two individuals and including a display screen measuring from a few inches to hundreds of feet. In this context, for example, the large-scale device 120 may comprise any display device from a small television or computer display to a large scale display screen and projector.

Network 50 may comprise any of a number of public or private networks, or a combination thereof, including but not limited to the Internet. Devices may couple to the content provider 150 to acquire content in a manner suitable for use by the content display device and in the manner which the content provider chooses to deliver it. Some devices may include non-volatile memory allowing them to store content for later use. Other devices may stream data directly from the content provider 150.

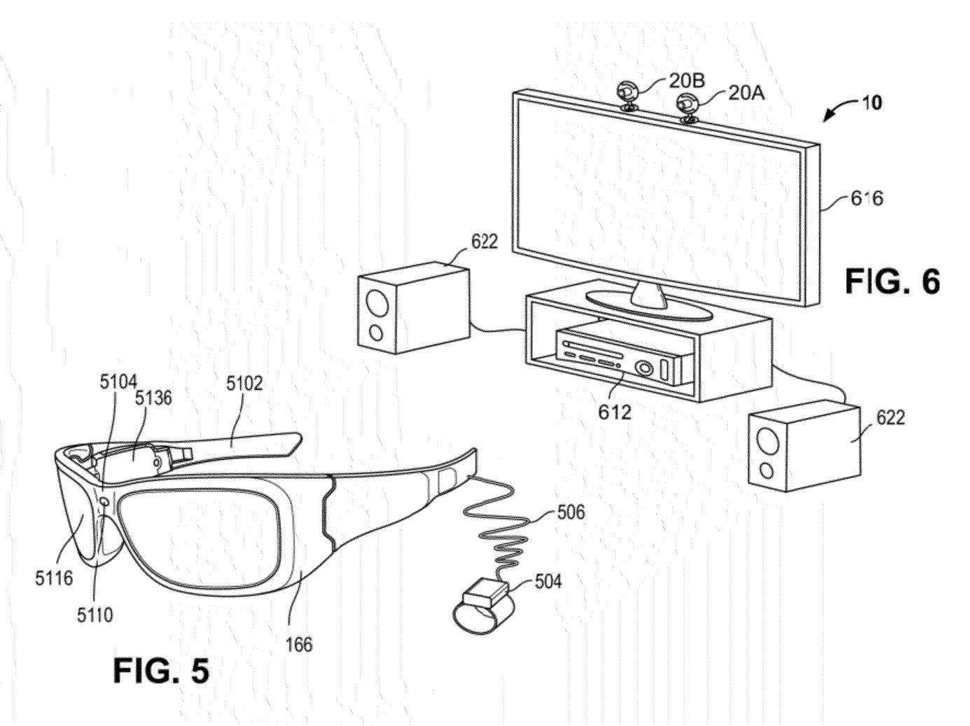

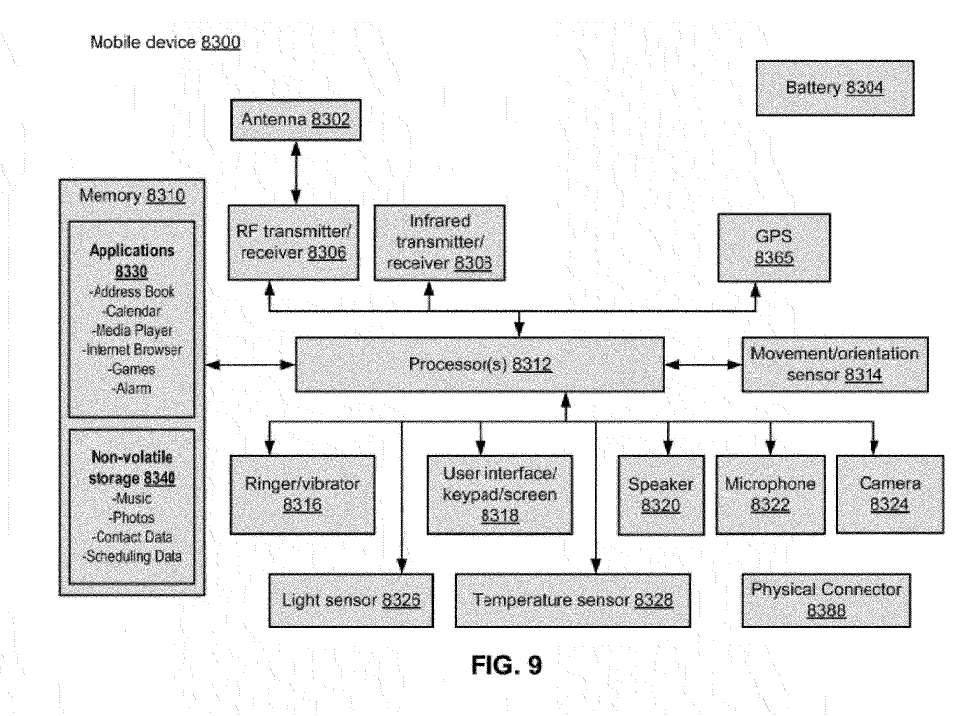

One type of display device may comprise a mobile display device 100 such as a portable phone or media player. One example of a mobile media device is illustrated in FIGS. 5 and 9. Mobile display device 100 includes a camera or capture device 102, such as a camera or other type of capture device, and a display 105. Included in the memory and application spade of the mobile media device are a license manager and a consumer detector. The license manager 104 may work alone or in concert with license manager 152 to determine whether performance of content on device 100 is consistent with the terms of the license associated with the content. In other embodiments, no license manager 104 is local to the device 100 and license management may occur on the content provider 150.

Consumer detector 106 works in conjunction with the camera or capture device 102 to determine the number of users or consumers within the display area 165 of display 105. In the example shown in FIG. 1, there are two users 162, 164, within the display area 165 of display 105. Using the imaging or other detection technology of the camera 102, the number of actual consumers of the content viewing the screen display 105 is determined for use by the license manager 104 (and/or 152) in enforcing the terms of the license.

In the case of the mobile display device, the display 105 is generally designed for use by one person but it is possible that more than one person may be able to view content on the display 105. As such the consumer detector uses data from the camera or capture device 102 to determine the number of consumers. In one example, camera 102 is an RGB imaging camera and the consumer detector analyzes one or successive images from the camera to ensure that the licensed number of users per view is enforced. In alternative embodiments, other technologies may be used for the camera/capture device 102, as discussed below. In still further embodiments, no consumer detector is provided on the mobile display device 100 and the consumer detection may be performed by a consumer detector on the content provider 150 as camera or capture device data is transmitted back to the content provider during a performance of the content.

A personal display device 110 may include a head mounted display 166 such as that shown in FIG. 5. A head mounted display may include processing means rendering the content in the display portion of the head mounted display 166, but generally would not require a consumer detector as the device itself limits the per-performance use of the content to a single user. The device may include a license manager 114 which functions as license manager 104 alone or in combination with license manager 152.

A large screen display 120 is a display system generally designed for use by a large number of users e.g. users 170-178. A large screen display device may include a license manager 122, consumer detector 124, capture device 128 and display 126. As noted, the field of display 125 of the display 126 is much larger than the mobile display device and is designed to display content to from one to sever hundred or even thousands of users simultaneously.

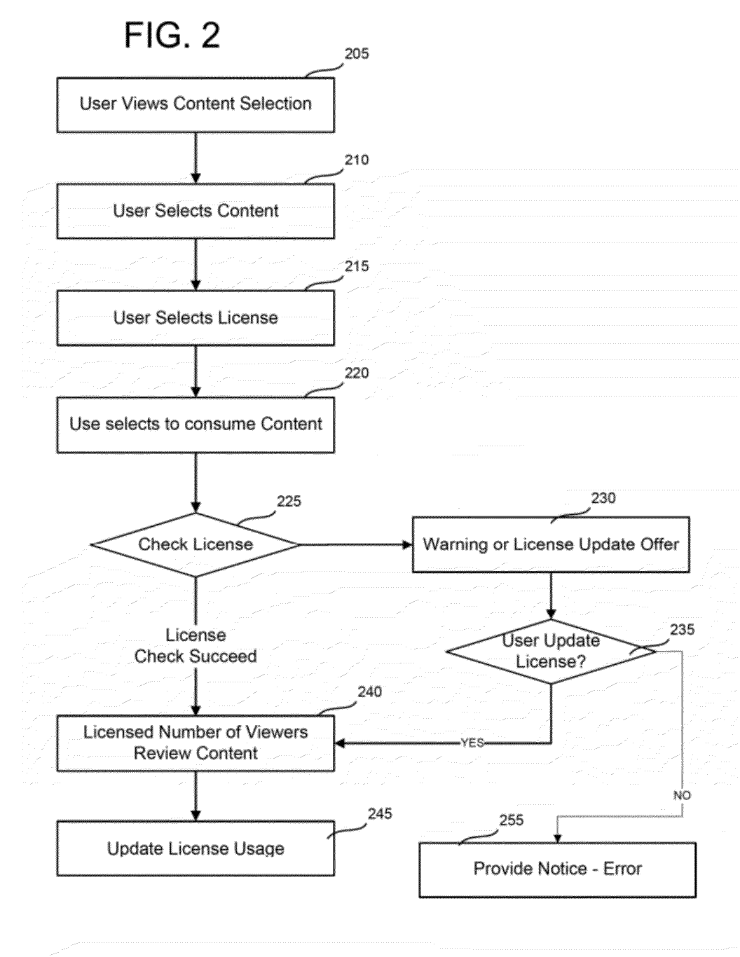

FIG. 2 illustrates a general method suitable for use in accordance with the present technology. At 205 a consumer views a selection of content generally available from the content provider. The content viewed may be from a single provider or multiple providers. At 210, the user selects content which the user wishes to view. At 215, the user selects a license option associated with the content. Each element of content may have one or more license options. Some content may only include one license option, while others may have various options. Each option may be associated with a license cost. In accordance with the technology, the license may be associated with actual user consumption based on detection of a user or consumer within a field of display of a display device. This provides a number of licensing options including, but not limited to regulating on the number of views (total viewers×content presentation) for the content; regulating the number of simultaneous views for each viewing of the content; regulating the number of views within a particular time period; regulating the number of views for an indeterminate large number of people; and/or any combination of the aforementioned examples. Licenses may also be tied to user identity. Using conventional user authentication methods, or the system of FIGS. 5 and 6 below, a license may be associated with a user identity so that individuals may view content based on their licensed identity. Each of these various types of licenses can be used alone or in combination with other licenses. User identity can be combined with “guest” or “unknown” user licenses at a given location. For example, a license regulating the number of simultaneous views at one location may be combined with a license allowing an identified user unlimited views so that additional simultaneous views at the location may be allowed. All such various combinations, and restrictions on combinations, of licenses are within the scope of the present technology.

In an alternative embodiment, a fee can be charged for each viewer of the content for each view. In another alternative, at 225 and 240, a per-viewer license may comprise counting the number of viewers in a viewing area and directly charging for each identified user in the viewing area. Viewers may be uniquely identified and a count of the viewers determined, with the licensee then charged for each viewer accessing the content. Age and identity restrictions can be applied in this embodiment as well.

Selection of the license at step 215 may include a transaction of remuneration for the content provider in exchange for the right to consume the content in accordance with the terms of the license. Once the license is selected at 215, the user may select to consume the content (view a video or listen to audio or play a game) at a subsequent point in time.

At step 220, the user selects to view the content subject to the terms of the license. At 225, a licensee check is made to determine whether the user has sufficient rights to consume the content. This check may include a determination of the number of users present at the consuming device and a determination of whether, for the particular performance of the content selected, the number of users relative to the number of views allowed is equal to or less than that specified in the license. If the license check is successful, then the licensed number of users is allowed to view the content at 240. If the license check is not successful at 225, then the user may be presented with a warning that the user has an insufficient license to consume the content relative to the number of licensed uses and may further be provided with the opportunity to update the license to include the number of users or views to allow the user to view the content. In certain instances, the user will only be presented with a warning at step 230 an no opportunity to update the license where, for example, the content provider has determined that a specific limitation on the content performance would preclude the consuming the content in the manner desired by the user.

If the user is presented with the option at 230 and chooses to update the license at 235, the licensed number of viewers is allowed to view the content at 240. If the user chooses not to update the license at 235, a notice that viewing the content on a device in the manner attempted by the user is not allowed at 255.

Once a view occurs at 240, the license usage is updated at 245. This may include updating a user record in the database 154 associated with the user relative to additional performances of the content. Step 245 may further include indicating that the license is expired (all uses have been made) such that a new license to consume the same content is required.

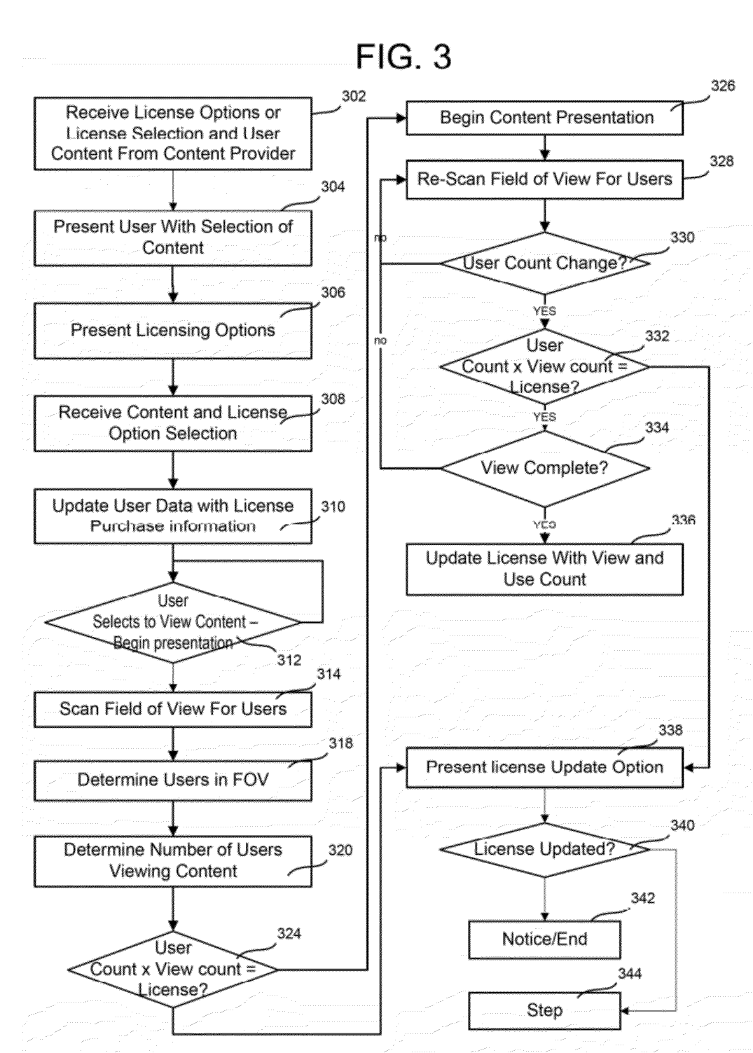

FIG. 3 is a flowchart illustrating the steps performed on a display device, such as devices 100, 110, 120, in accordance with the present technology. At 302, a display device may receive a set of license options and available user content from one or more content providers. The devices 100, 110, 120 may use this information to present the user with a selection of content available for consumption at 304. At 306, licensing options for the available content is presented and 306 may be preformed concurrently or in reverse order. The particular user interface presented to the user may depend on the type of device which the user wishes to use to consume the content and the availability of the content for the device.

At 308, the user selection is of content and a licensing option for the content is received at the device. In one embodiment, this may include downloading the content and associated licensing information to enable a performance program on the display device to present the content on the device. At 310, the user record selection is set to the content server for updating of the database 154.

At 312, which may be temporally just after step 308 or separated in time from step 308, a user selects to consume the content. Step 312 may include beginning the presentation of the content at the display device by a presentation application on the display device, or indicating to the content provider to begin presentation of the content to the display device. At 314, a scan of the display area of the associated display device is made to determine the number of users in the field. As noted, this may comprise using the available capture device or camera, comprising one of a number of suitable technologies, to determine the number of uses present who can consume the content presented. At 318, using the information from the capture device, the number of users in the display area is presented. In this context, display area may include an audio performance area where the content is audio only. In one embodiment, step 318 is not performed on the client device but rather on the content provider device. In such embodiments, step 318 may comprise outputting the capture device information to the content provided. At step 320 the number of content consumers is determined. In some cases, the number of users in the display area of the display device will equal the number of content consumers. In alternate embodiments, content consumers may be determined by more complex gestures. For example, the capture device may note a specified number of people within the display area of a display device, but determine that a subset of the people in the display area are too far to benefit from the display of the content or otherwise not available to view the content. In such cases, at 320, the number of user determined to be consuming the content may be less than those in the display area. Multiple display devices with multiple display areas can be combined to determine whether the specified number of individuals meets the licensed definition of allowed viewers.

At 324, a license validation is performed by comparing the user count and any view or performance limitation against that allowed by the license. If the license is satisfied, the content presentation begins at 326. If not, then at 338, the user is presented with an option to adjust the license terms. If the license is updated, then the content presentation begins at 326. If not, the presentation is halted at 642.

Once the presentation begins at 326, the users in the field of view may change over the course of the presentation. Users may enter or leave the display area of a display device, for example. At 328, the display area for the display device is re-scanned. At 330, a determination is made as to whether the consuming user count has changed. Again, the content provider based on information provided to the content provider by the display device may perform step 330. In such embodiments, the content provider performs step 330. At 332, a comparison of the user count and any view or performance limitation against that allowed by the license is again made. If the license is exceeded, the process moves to step 338 to offer an opportunity to change the license terms. If the count has not changed, a determination is made at 334 whether performance of the content has been completed.

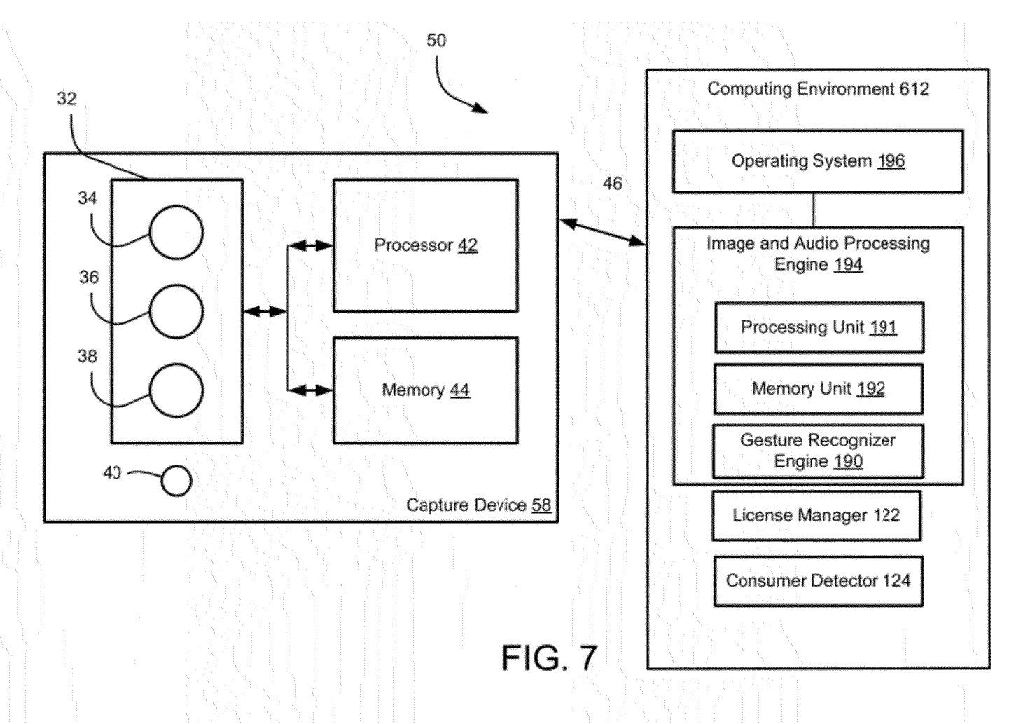

Various algorithms may be used to determine whether a user present within the display area of the display device has consumed enough of the content for such consumption to be considered a “use” of the content. One algorithm is to determine how many users have consumed a majority or some minimum threshold of the content. In a further embodiment, where a capture device in accordance with FIG. 7 is used, individuals may be specifically identified and the amount of their consumption of the content tracked relative to their specific use.

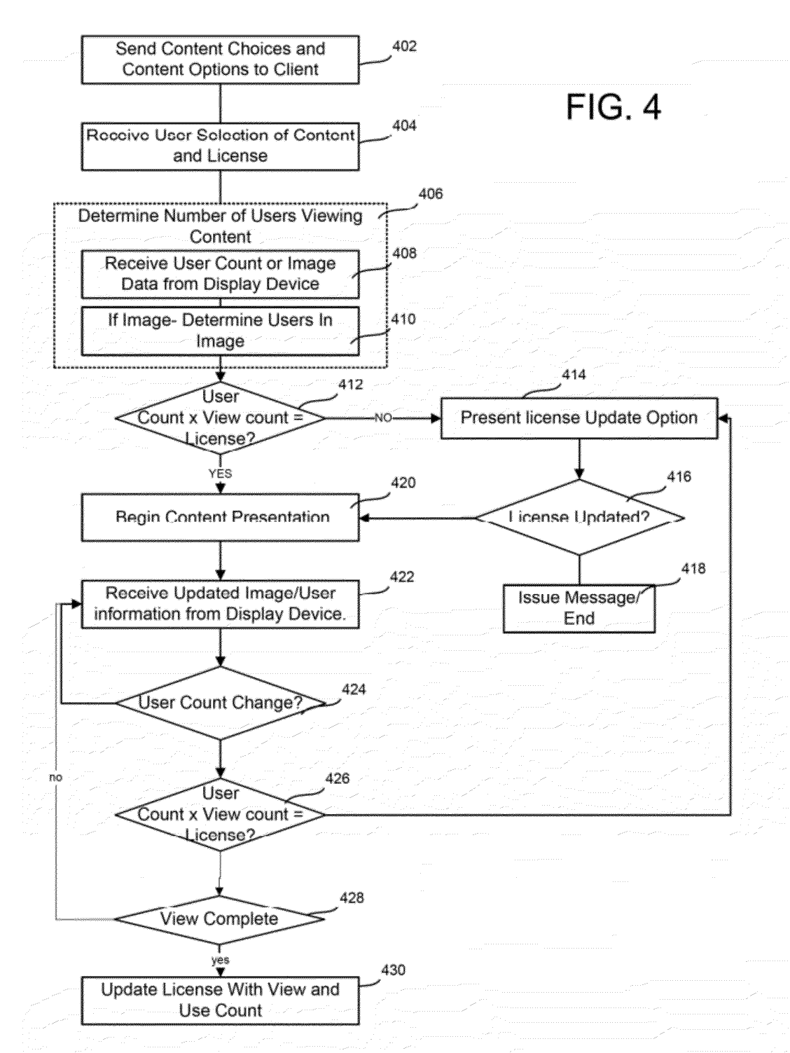

FIG. 4 is a flowchart illustrating a method preformed by a content provider in accordance with the present technology. At 402, the content choices and license options are sent to a display device. At 404, a selection of the content and the license choice is received from the display device.

Steps 406-426 may be performed when the content provider 150 controls presentation of the content to the display device and/or license management is performed on the display device. In cases where the display device presents content directly, steps 406-426 may not need to be performed. In other embodiments, for example where content is streamed directly from the content provider 150 and the display device does not include a presentation application or content storage, license management is performed on the content provider 150.

At 406, a determination is made as to the number of users viewing the content. Step 406 may include directly receiving a determined user count at 408 from the display device, or receiving data from the capture device at 410 which may then be used by the content provider to determine the consumers of the content in the display area of the device.

At 412, a license validation is performed by comparing the user count and any view or performance limitation against that allowed by the license. If the license is satisfied, the content presentation begins at 420. If not, then at 414, the user is presented with an option to adjust the license terms. If the license is updated at 416, then the content presentation begins at 420. If not, the presentation is halted at 418.

At 422, updated capture device information may be received from the display device. At 424, a user count determination is made in a manner similar to step 330 described above using one of a number of alternative algorithms. At 426, another license validation is performed using the updated user count information from step 422. If the license is not satisfied, then a license update option is presented at 414. If the license is valid with the updated user count, then at 428 a determination is made as to whether a view is complete. If not, the method loops to step 422 but if so, then the license is updated at 430.

It will be understood by those of average skill in the art that numerous variations on the performance of the above teachings may be performed by various components of the content provider processing devices and the display devices.

FIG. 5 depicts example components of one embodiment of a head mounted display device 166 in communication with processing unit 504 via wire 506. In other embodiments, head mounted display device 502 communicates with processing unit 504 via wireless communication. Head mounted display device 502, which in one embodiment is in the shape of glasses, is worn on the head of a user so that the user can see through a display and thereby have an actual direct view of the space in front of the user. The use of the term “actual and direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

In one embodiment, processing unit 504 is worn on the user's wrist and includes much of the computing power used to operate head mounted display device 502. Processing unit 504 communicates wirelessly (e.g., WiFi, Bluetooth, infra-red, or other wireless communication means) to one or more computing environments 612 illustrated in FIGS. 6 and 8-10.

A head mounted display device 502, may include microphone and or camera 5110 for recording sounds and transmitting that audio data to processing unit 504, as described below.

A portion of the frame of head mounted display device 166 will surround a display (that includes one or more lenses). In order to show the components of head mounted display device 502, a portion of the frame surrounding the display is not depicted. Various technologies may be used to enable the head mounted display 502, with such technologies using a separate processing device 504 and some not using a separate processing device, but rather receiving information directly from the content provider or from a computing environment. Mounted to or inside may be imaging electronics 5136, which (in one embodiment) drive a micro display for projecting a virtual image on lens 5116 images. Additional details of and an exemplary head mounted display suitable for use in the present technology is presented in copending U.S. patent application Ser. No. 12/905,952 entitled Fusing Virtual Content Into Real Content, filed Oct. 15, 2010, owned by the assignee of the present application and hereby fully incorporated by reference herein. Other head mounted displays may be utilized in accordance with the present technology.

As illustrated in FIG. 6, a computing environment 612 may be a computer, a gaming system or console, or the like. According to an example embodiment, the computing environment 612 may include hardware components and/or software components such that computing environment 612 may be used to execute applications such as gaming applications, non-gaming applications, or the like. In one embodiment, computing environment 612 may include a processor such as a standardized processor, a specialized processor, a microprocessor, or the like that may execute instructions stored on a processor readable storage device for performing the processes described herein.

Computing environment 612 further include one or more capture devices, such as capture device 20. A capture device is further illustrated in FIG. 7. One or multiple capture devices may be used. Capture device 20 may be, for example, a camera that visually monitors one or more users and the surrounding space such that gestures and/or movements performed by the one or more users, as well as the structure of the surrounding space, may be captured, analyzed, and tracked to perform one or more controls or actions within the application and/or animate an avatar or on-screen character.

Computing environment 612 may be connected to an audiovisual display device 616 such as a television, a monitor, a high-definition television (HDTV), or the like that may provide game or application visuals. For example, computing environment 612 may include a video adapter such as a graphics card and/or an audio adapter such as a sound card that may provide audiovisual signals associated with the game application, non-game application, etc. The audiovisual device 616 may receive the audiovisual signals from computing environment 612 and may then output the game or application visuals and/or audio associated with the audiovisual signals. According to one embodiment, the audiovisual device 16 may be connected to computing environment 612 via, for example, an S-Video cable, a coaxial cable, an HDMI cable, a DVI cable, a VGA cable, component video cable, RCA cables, etc. In one example, audiovisual device 616 includes internal speakers. In other embodiments, audiovisual device 616, a separate stereo or computing environment 612 is connected to external speakers 620.

Environment 612, with capture device 20, may be used to recognize, analyze, and/or track human (and other types of) targets. For example, a users within the display area of the display 616 may be tracked using the capture device 620 such that the gestures and/or movements of the user may be captured to determine the number of people present, whether users are viewing content (in accordance with step 320) and/or may be interpreted as controls that may be used to affect the application being executed by computing environment 612. Such information may also be used to determine whether the tracked user is viewing content presented by a content provider.

FIG. 7 illustrates a capture device 58 coupled to a functional representation of a computing environment 612. The capture device 58 may include one or more image sensors for capturing images and videos. An image sensor may comprise a CCD image sensor or a CMOS sensor. In some embodiments, capture device 58 may include an IR CMOS image sensor. The capture device 58 may also include a depth camera (or depth sensing camera) configured to capture video with depth information including a depth image that may include depth values via any suitable technique including, for example, time-of-flight, structured light, stereo image, or the like.

The capture device 58 may include an image camera component 32. In one embodiment, the image camera component 32 may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

The image camera component 32 may include an IR light component 34, a three-dimensional (3-D) camera 36, and an RGB camera 38 that may be used to capture the depth image of a capture area. For example, in time-of-flight analysis, the IR light component 34 of the capture device 58 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 58 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

In another example, the capture device 58 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets (or objects) in the capture area, the pattern may become deformed in response. Such a deformation of the pattern may be captured by, for example, the 3-D camera 36 and/or the RGB camera 38 and analyzed to determine a physical distance from the capture device to a particular location on the targets or objects.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used or any combination and number of cameras may be used. In one embodiment, the capture device 58 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As shown in FIG. 7, capture device 58 may include a microphone 40. The microphone 40 may include a transducer or sensor that may receive and convert sound into an electrical signal. In one embodiment, the microphone 40 may be used to reduce feedback between the capture device 20 and the computing environment 54. Additionally, the microphone 40 may be used to receive audio signals that may also be provided by the user to control applications such as life recording applications or the like that may be executed by the computing environment 54.

In one embodiment, the capture device 58 may include a processor 42 that may be in operative communication with the image camera component 32. The processor 42 may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 58.

The capture device 58 may include a memory component 44 that may store the instructions that may be executed by the processor 42, images or frames of images captured by the 3-D camera or RGB camera, or any other suitable information, images, or the like. In one example, the memory component 44 may include random access memory (RAM), read only memory (ROM), cache, Flash memory, a hard disk, or any other suitable storage component. As shown in FIG. 2B, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 58 illustrated in FIG. 2B are housed in a single housing.

The capture device 58 may be in communication with the computing environment 54 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 54 may provide a clock to the capture device 58 that may be used to determine when to capture, for example, a scene via the communication link 46. In one embodiment, the capture device 58 may provide the images captured by, for example, the 3-D camera 36 and/or the RGB camera 38 to the computing environment 54 via the communication link 46.

As shown in FIG. 7, computing environment 612 includes image and audio processing engine 194 in communication with operating system 196. Image and audio processing engine 194 includes gesture recognizer engine 190, structure data 198, processing unit 191, and memory unit 192, all in communication with each other. Image and audio processing engine 194 processes video, image, and audio data received from capture device 58. To assist in the detection and/or tracking of objects, image and audio processing engine 194 may utilize structure data 198 and gesture recognition engine 190.

Processing unit 191 may include one or more processors for executing object, facial, and voice recognition algorithms. In one embodiment, image and audio processing engine 194 may apply object recognition and facial recognition techniques to image or video data. For example, object recognition may be used to detect particular objects (e.g., soccer balls, cars, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192.

In some embodiments, one or more objects being tracked may be augmented with one or more markers such as an IR retroreflective marker to improve object detection and/or tracking. Upon detection of one or more targets or objects, image and audio processing engine 194 may report to operating system 196 an identification of each object detected and a corresponding position and/or orientation.

The image and audio processing engine 194 may utilize structural data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize gesture recognizer engine 190 while performing object recognition. In one example, gestures recognizer engine 190 may include a collection of gesture filters, each comprising information concerning a gesture that may be performed by a skeletal model. The gesture recognition engine 190 may compare the data captured by capture device 58 in the form of the skeletal model and movements associated with it to the gesture filters in the gesture library 192 to identify when a user (as represented by the skeletal model) has performed one or more gestures. In one example, image and audio processing engine 194 may use the gesture recognition engine 190 to help interpret movements of a skeletal model and to detect the performance of a particular gesture.

A license manager 122 and consumer detector, operating as described above, may also be provided—alternatively, license management and consumer detection is provided on the content providers system.

More information about gesture recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

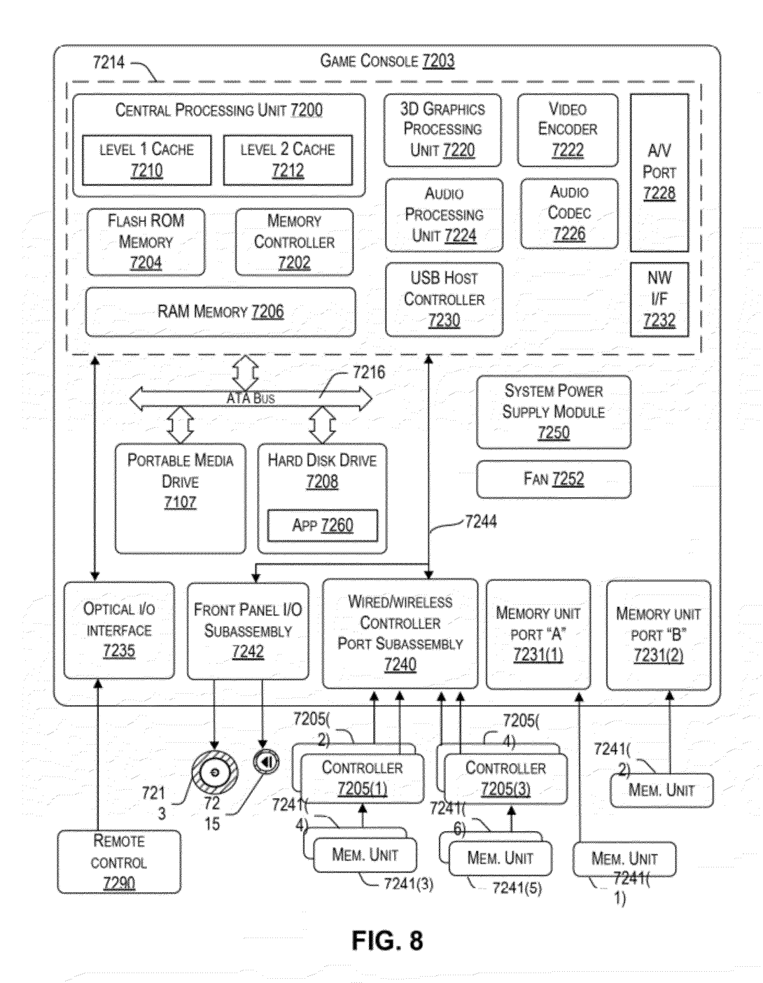

FIG. 8 shows one implementation of a computing environment 612 comprising a gaming console. Gaming console 7203 includes module 7214 including a USB host controller 7230 and a network interface 7232. USB host controller 7230 is in communication with CPU 7200 and memory controller 7202 via a bus (not shown) and serves as host for peripheral controllers 7205(1)-7205(4). Network interface 7232 provides access to a network (e.g., Internet, home network, etc.) and may be any of a wide variety of various wire or wireless interface components including an Ethernet card, a modem, a wireless access card, a Bluetooth® module, a cable modem, and the like.

In the implementation depicted in FIG. 8, console 7203 includes a controller support subassembly 7240 for supporting four controllers 7205(1)-7205(4). The controller support subassembly 7240 includes any hardware and software components needed to support wired and wireless operation with an external control device, such as for example, a media and game controller. A front panel I/O subassembly 7242 supports the multiple functionalities of power button 7213, the eject button 7215, as well as any LEDs (light emitting diodes) or other indicators exposed on the outer surface of console 7203. Subassemblies 7240 and 7242 are in communication with module 7214 via one or more cable assemblies 7244. In other implementations, console 7203 can include additional controller subassemblies. The illustrated implementation also shows an optical I/O interface 7235 that is configured to send and receive signals (e.g., from remote control 7290) that can be communicated to module 7214.

MUs 7241(1) and 7241(2) are illustrated as being connectable to MU ports “A” 7231(1) and “B” 7231(2) respectively. Additional MUs (e.g., MUs 7241(3)-7241(6)) are illustrated as being connectable to controllers 7205(1) and 7205(3), i.e., two MUs for each controller. Controllers 7205(2) and 7205(4) can also be configured to receive MUs (not shown). Each MU 7241 offers additional storage on which games, game parameters, and other data may be stored. Additional memory devices, such as portable USB devices, can be used in place of the MUs. In some implementations, the other data can include any of a digital game component, an executable gaming application, an instruction set for expanding a gaming application, and a media file. When inserted into console 7203 or a controller, MU 7241 can be accessed by memory controller 7202. A system power supply module 7250 provides power to the components of gaming system 7201. A fan 7252 cools the circuitry within console 7203.

An application 7260 comprising machine instructions is stored on hard disk drive 7208. When console 7203 is powered on, various portions of application 7260 are loaded into RAM 7206, and/or caches 7210 and 7212, for execution on CPU 7200. Other applications may also be stored on hard disk drive 7208 for execution on CPU 7200.

Gaming and media system 7201 may be operated as a standalone system by simply connecting the system to a monitor, a television, a video projector, or other display device. In this standalone mode, gaming and media system 7201 enables one or more players to play games or enjoy digital media (e.g., by watching movies or listening to music). However, with the integration of broadband connectivity made available through network interface 7232, gaming and media system 7201 may further be operated as a participant in a larger network gaming community.

FIG. 9 is a block diagram of one embodiment of a mobile device 8300. Mobile devices may include pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

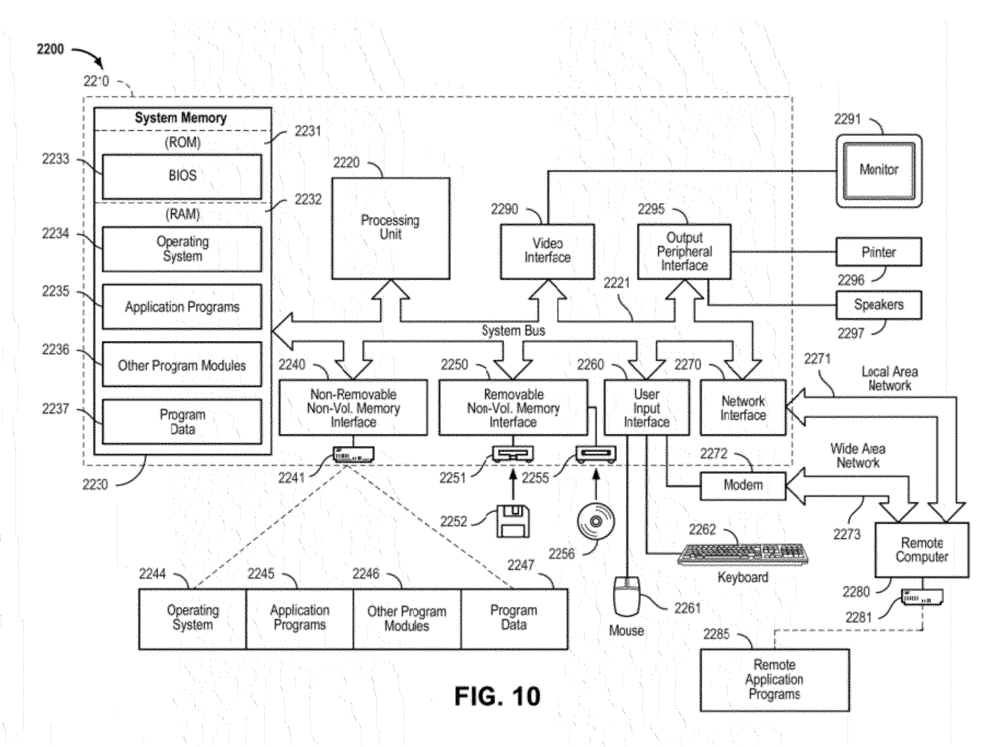

FIG. 10 is a block diagram of an embodiment of a computing environment 612 which may comprise a personal computing system environment 2200. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 10 illustrates operating system 2234, application programs 2235, other program modules 2236, and program data 2237.

The computer 2210 may also include other removable/non-removable, volatile/nonvolatile computer storage media. By way of example only, FIG. 10 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 10, provide storage of computer readable instructions, data structures, program modules and other data for the computer 2210. In FIG. 10, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated in FIG. 10. The logical connections depicted in FIG. 10 include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 10 illustrates remote application programs 2285 as residing on memory device 2281. It will be appreciated that the network connections shown are exemplary and other means of establishing a communications link between the computers may be used.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I (We) claim:

1. A method of distributing content to a user, comprising:
providing a selection of content available to the user;
for each content, presenting a licensing option comprising associating a performance of the content with an individual user's consumption of the content at a display device;
receiving a selection of one of the content and a license display option for said content;
presenting the content to the display device if a number of user performances allowed for the content is equal to or less than the license option for which the selection is received; and
monitoring the presentation of the content at the device to determine the number of users consuming the content during the performance.

2. The method of distributing content of claim 1 wherein the license comprises an absolute limited number of user performances.

3. The method of claim 1 wherein the license comprises a limited number of user performances within a period of time.

4. The method of claim 1 wherein the license comprises a limited number of user performances per device.

5. The method of claim 1 further including continuously monitoring a number of users at a display device during the performance of the content.

6. The method of claim 5 further including determining whether a number of users at a display device exceeds the license option during the performance of the content.

7. The method of claim 6 further including presenting the user an option to change the license if a number of allowed user performances in a license is exceeded during performance of the content at the display device.

8. A computer implemented method for distributing limited play content to a user, comprising:
transmitting a selection of audiovisual content to a display device, each content having one or more associated license option, each license option allowing a specified number one or more presentations to one or more users on the display device;
receiving a selection of one of the content and a selection of a licensing option for said content;
determining a number of users at the display device prior to presenting the content;
presenting the content on the display device if the number of users at the display device is equal to or lower than that specified in the licensing option; and
monitoring the presentation of the content to determine a number of viewers of the content during presentation of the content at the display device.

9. The method of claim 8 further including continuously monitoring a number of users at a presentation device during the presentation of the content.

10. The method of claim 9 further including determining whether a number of users at a presentation device exceeds the license option during the presentation of the content.

11. The method of claim 10 further including presenting the user an option to change the license if a number of allowed user views in a license is exceeded during performance of the content.

12. The method of claim 8 wherein the license option comprises a limited display of user views of the content.

13. The method of claim 12 further including determining a user view by determining at least a number of users within a display area of a display device for a duration of the presentation exceeding a threshold.

14. The method of claim 12 further including identifying specific users within a display area of a display device and associating a duration of the presentation with each user, and determining a user view when performance of the content to an identified user exceeds a threshold.

15. A computer readable medium including instructions providing a processing device to perform the steps of:
providing a selection of display content, each content having one or more associated licenses allowing a limited number of user views of the content;
receiving a selection of one of the content and a license display option for said content;
scanning a display area of a display device selected for performance of the content;
determining a number of users capable of viewing the performance at the display device;
determining if the license display option is met;
presenting the content on the device if a number of user views allowed for the content within a specific time period is equal to or less than the selection of the license display option;
continuously monitoring the presentation of the content to determine the number of users consuming the content during the performance.

16. The computer readable medium of claim 15 further including determining whether a number of users at a presentation device exceeds the license option during the presentation of the content.

17. The computer readable medium of claim 16 further including determining a user view by determining at least a number of users within a display area of a display device for a duration of the presentation exceeding a threshold.

18. The computer readable medium of claim 16 further including identifying specific users within a display area of a display device and associating a duration of the presentation with each user, and determining a user view when performance of the content to an identified user exceeds a threshold.

19. The computer readable medium of claim 16 further including presenting the user an option to change the license if a number of allowed user views in a license is exceeded during performance of the content.

20. The computer readable medium of claim 15 wherein the license comprises a limited user views within a display period.
